(19) United States
(12) Patent Application Publication
(10) Pub. No.: US 2017/0071241 A1
(43) Pub. Date: Mar. 16, 2017

(54) Komba Multi Purpose Sauce

(71) Applicant: Isata Kumba Komba, Woodbridge, VA (US)

(72) Inventor: Isata Kumba Komba, Woodbridge, VA (US)

(21) Appl. No.: 14/748,246

(22) Filed: Jun. 24, 2015

(51) Int. Cl. A23L 23/00

(52) U.S. Cl. CPC A23L 23/00; A23V 2002/00

(57) ABSTRACT

The present invention discloses a novel recipe and process of preparing a lamb leg sauce, wherein the sauce is freshly prepared that can be refrigerated for future use. The novel sauce recipe comprises of boneless lamb leg, rosemary, thyme, maggi powder, single fresh albernero, garlic, onion, tomatoes, cucumbers, sweet mini pepper, bell peppers, American leek, and olive oil.

### CROSS REFERENCE TO RELATED APPLICATION

Not Applicable

### FEDERALLY SPONSORED RESEARCH AND DEVELOPMENT

Not Applicable

### MICROFICHE APPENDIX

Not Applicable

### BACKGROUND OF THE INVENTION

(1) Field of the Invention

The present invention relates to a process for making microwave sauce comprising boneless lamb leg to be served with variety of dishes. More particularly, the present invention related to a process for preparing refrigerated meals.

(2) Background of the Invention

In cooking, a sauce is liquid, cream or semi-solid food served on or used in preparing other foods. Sauces are not normally consumed by themselves; they add flavor, moisture, and visual appeal to another dish. Sauce is a French word taken from the Latin salsa, meaning salted. Possibly the oldest sauce recorded is garum, the fish sauce used by the Ancient Greeks.

Sauces need a liquid component, but some sauces (for example, pico de gallo salsa or chutney) may contain more solid elements than liquid. Sauces are an essential element in cuisines all over the world.

A sauce can also be sweet, and used either hot or cold to accompany and garnish a dessert. Another kind of sauce is made from stewed fruit, usually strained to remove skin and fibers and often sweetened. Such sauces, including apple sauce and cranberry sauce, are often eaten with specific other foods (apple sauce with pork, ham, or potato pancakes; cranberry sauce with poultry) or served as desserts.

Lamb meat is, by its very nature, gamey and barnyard-y tasting—it's one of the reasons why the meat is not as popular as mild chicken or beef, and while one can love that funky aroma. Also, while cooking for guests, one can find ways to try and keep it at least slightly under wraps. Australian and New Zealand lamb tends to be smaller and milder in flavor than their larger American counterparts, but the size of American lamb legs are most preferable. They're more festive, and it makes it much easier to end up with a nice rosy red center and crisp exterior.

There are various advantages associated with cooking of boneless lamb leg that includes: By boning out the leg and butterflying it, one gets a chance to remove the large pockets of fat (which tend to be localized around a few major inter-muscular glands), thereby reducing its gaminess while also making the lamb easier to carve and more pleasant to eat. Exterior crisp fat can be great, but too much soft, greasy interior fat can be excessive.

Next advantage being one can season it inside and out. There are many flavor combinations that go well with lamb—a good North African ras el hanout rub or a slathering of harissa paste with minced garlic, Olive paste with Mediterranean herbs. Even plain old salt and pepper, if all you want to taste is the meat can also work wonders.

The important and evergreen method comes with the classic combination of garlic, rosemary, and lemon zest, along with some shallots, which bring their milder allium sweetness to the mix. Both garlic and onions change in flavor as they're heated and don't really lose their raw, pungent edge and attain sweetness until they hit well into the 300°+ range. Since the interior of our lamb leg is not cooked beyond a medium to medium-rare 135° F. and aromatic blend is being applied directly to the interior of the roast, it needs to be cooked before it goes on the lamb.

One can also try cooking down in olive oil, adding a pinch of red pepper flakes for heat, and a few minced anchovy filets (another classic lamb pairing). All it does is to boost the meatiness of the lamb by providing a concentrated source of glutamic and inosinic acids, two proteins that trigger our sensation of savories.

Another advantage of cooking boneless lamb leg is that its easier to take the temperature of a boneless lamb leg. Different materials conduct heat differently. Last but not least, the boneless lamb leg is darn easy to slice and serve. The average time spent by consumers for preparing hot meals has declined considerably in the last decade. Convenience in food preparing has become an important issue, as is illustrated by the popularity of microwave ovens in the preparation of full meals.

However, it has been found that the preparation of tasty warm sauces in microwaves is still a challenge. Warm sauces have a tendency to boil-over, unless the heating is carried out in a multistep heating process, with the requirement of manual stirring in between heating steps. Further, browning of the sauce due to excessive heating (Mallard reaction), is often observed. In addition, in sauces comprising garnish, viz, particles of considerable size (e.g. 1 mm or more), and these particles tend to discolor and/or lose texture.

Further, the inventors realized that for reasons of convenience it would be desirable to allow both heating of the sauce in a microwave oven and the serving of the warm sauce whilst maintaining good flavor and scent.

Accordingly, the present invention relates generally to a process for producing prepared foods. More particularly, the present invention relates to a process for preparing refrigerated meals.

To maintain the prepared meals with a desired quality until the prepared meals are consumed, prepared meals are typically frozen during the manufacturing process. The prepared meals are then maintained frozen until it is desired to heat the prepared meal for consumption. Frozen prepared meals are typically thawed and heated using a microwave oven. The frozen prepared meals thereby provide consumers with the ability to quickly prepare meals while minimizing the effort that must be expended to prepare the meals.

### SUMMARY

It is an object of the present invention to provide a novel sauce recipe comprising of boneless lamb leg to be served in conjunction with other dishes.

The present invention includes a process for preparing a refrigerated prepared multipurpose sauce. The process includes selecting food components from the group consisting essentially of a starch component, a meat component, a vegetable component, a sauce component, and a spice component. The food components are cooked and then mixed to produce a food mixture.

The inventor of the present invention has found, surprisingly, that by combining certain ingredients and employing particular cooking techniques, a multipurpose sauce can be prepared that can be refrigerated and microwaved as and when needed prior to its use.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### DETAILED DESCRIPTION OF THE INVENTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The present invention relates to food more particularly, to a microwave sauce wherein the sauce is freshly prepared and then refrigerated to be used later. The refrigerated sauce is heated in microwave or over the stove to be used as and when needed.

In one embodiment, the present invention has a unique taste with no preservatives added. In a preferred embodiment, the present invention is a multipurpose and healthy sauce with no added sugar or salt wherein the invention can taste great with or without meat

An aspect of the present invention involves process for preparing the aforementioned multipurpose sauce which includes:
(i) Two pounds of leg of lamb boneless (fat removed) chopped into bite size
(ii) Marinate it with 1 tbsp of fresh rosemary, 1 tbsp of fresh thyme; 1 tbsp of chopped garlic; 1 tbsp of maggi powder, 1 small single fresh albernero pepper.
(iii) Cook lamb with 1 cup of water or until the Iamb is tender; all the liquid is evaporated
(iv) Rest of the ingredients include: 1 pound of sweet mini pepper (chopped), chopped bell pepper (red, orange and yellow); ½ cup of chopped American leek; 2% cup of red onion; 2 tbsp of powdered maggi, 3 chopped plum tomatoes, 3 tbsp of olive oil; 1 chopped seedless cucumber.

Another aspect of the present invention involves the process for preparing the same wherein in a big nonstick pan, olive oil is heated, chopped garlic and onions are stir fried, freshly chopped vegetables and maggi powder is added and cooked for 20 minutes. After that, pre-cooked lamb is added to the mixture and further cooked for next 5 minutes. The sauce is ready after heating it for 25 minutes.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

It is to be understood that the above description is intended to be illustrative, and not restrictive.

I/We claim:

1. A freshly prepared sauce comprising:
(a) boneless Iamb leg;
(b) rosemary;
(c) fresh thyme;
(d) garlic;
(e) maggi powder;
(f) fresh albernero pepper;
(g) sweet mini pepper & ball peppers;
(h) american leek;
(i) red onion, tomatoes and cucumber; and
(j) olive oil.

2. The sauce as claimed in claim 1, wherein the ingredients are mixed in a proportion as follows:
Two pounds of leg of lamb boneless (fat removed) chopped into bite size
Marinate it with 1 tbsp of fresh rosemary; 1 tbsp of fresh thyme; 1 tbsp of chopped garlic; 1 tbsp of maggi powder; 1 single fresh albernero pepper,
Cook lamb with 1 cup of water or until the lamb is tender; all the liquid is evaporated
Rest of the ingredients include: 1 pound of sweet mini pepper (chopped); chopped bell pepper (red, orange and yellow); ½ cup of chopped American leek, 2 cup of red onion, 2 tbsp of powdered maggi; 3 chopped plum tomatoes; 3 tbsp of olive oil, 1 chopped seedless cucumber.

3. The sauce as claimed in claim 1, wherein the freshly prepared sauce can be refrigerated for later use.

4. A process for preparing a lamb leg sauce, which further comprises of following steps:
Heating olive oil in a big nonstick pan;
Stir-frying chopped garlic and onions;
Adding chopped vegetables and maggi powder;
Cooking the whole mixture for 20 minutes;
Adding pre-cooked lamb to the mixture and cooking it further for next 5 minutes; and
The sauce is ready to be served.
